(19) United States
(12) Patent Application Publication
(10) Pub. No.: US 2003/0144889 A1
(43) Pub. Date: Jul. 31, 2003

(54) Building transportable by water, a method for arranging delivery of an additional building to a desired location, a reservation system for premises and a method for reserving premises

(76) Inventor: Pekka Niemi, Turku (FI)

Correspondence Address: NIXON & VANDERHYE, P.C., 8th Floor, 1100 North Glebe Road, Arlington, VA, 22201, US

(21) Appl. No.: 10/043,280

(22) Filed: Jan. 14, 2002

(51) Int. Cl. G06F 17/60; B63B 35/44

(52) U.S. Cl. 705/5; 705/1; 114/258

(57) ABSTRACT

The invention relates to a building transportable by water, which comprises means for the transport thereof and transport premises for the accommodation of the transport personnel during the transport, which premises meet the safety regulations required of waterborne vessels. The building further comprises functional premises to be reserved by clients, which premises are dimensioned for a maximum number of clients C, and which do not meet the safety regulations required of waterborne vessels. The invention further relates to a method for arranging the delivery of the building to a desired location, a reservation system for the premises and a method for reserving the premises.

### FIELD OF THE INVENTION

The invention relates to a building as claimed in the preamble of the independent claim presented below, which building is transportable by water, but intended to be used especially when stationary, and particularly to a group of buildings consisting of several buildings of this type. The invention also relates to a new method, by means of which buildings of this type can be placed according to need. The invention also relates to a new type of reservation system and a reservation method for the premises comprised in the buildings according to the invention. The premises comprised in the buildings according to the invention may be used, for example, as a hotel, a residential building, an office, a hospital, temporary accommodation in a catastrophe area, an emergency centre, a military firing control centre, research and development premises or an industrial plant, such as a mobile telephone factory.

### PRIOR ART

Buildings constructed on land are typically located permanently on their building sites. They cannot be moved when necessary. Building is expensive, time-consuming and constitutes a considerable load on the environment. Therefore, it is not worthwhile to build, e.g. hotels, even to meet extensive, short-term needs, for example, in cities hosting Olympic Games or World Exhibitions. In the centres of large cities there is a shortage of premises, such as accommodation and office premises. City centres are often already built up, and no planning consents are granted for new buildings. Many cities have harbours that need cleaning up and revival of activities. Arranging acceptable accommodation and the services people need, for example, in catastrophe areas, is also very difficult and slow. Attempts to solve the above problems have been made by means of various constructions located in or on water. It is known to transport a single old cruise ship to operate as a hotel, for example, in the vicinity of a congress. Old ships have been designed to meet the requirements for ships, and refurbishing them to meet modern accommodation and office needs is extremely expensive. For example, the room spaces in ships are originally small, and the engine rooms are built in such a way that they take up ample space. German patent publication DE 4004673 describes houses built on barges or the like, which may be used as hotels. The seaworthiness of this type of construction is poor, and thus transporting them rapidly, for example, in ocean conditions is almost impossible. International patent publication WO 99/20521 discloses a floating building resembling a ship, which can be transported from one place to another.

Nowadays, buildings that are transportable by water, but can be used by people when stationary, for example, as accommodation or office premises, are expensive to build or difficult to transport. Moreover, until now, no satisfactory solutions have been found to the problem arising from different building regulations for building on land and for shipbuilding.

There are many known reservation systems for different types of buildings located on land and the premises they comprise, such as hotels and hotel rooms. There are also several reservation systems for ships, such as those for reserving cabins on a cruise ship. Current reservation systems do not take into account the special needs of buildings transported by water but used when stationary.

The aim of the present invention is to reduce, or even eliminate, the foregoing problems appearing in the prior art.

A particular aim of the invention is to provide a building that can be transported safely and rapidly by water if necessary, but which, when stationary, is intended for accommodation and office premises or the like for people. A particular aim of the invention is to provide an easily manageable group of buildings comprised of one or more of the type of building described above. A further aim is to provide a method and system for reserving the premises the building and the group of buildings comprise.

### SUMMARY OF THE INVENTION AND ITS PREFERRED EMBODIMENTS

To achieve the above-mentioned aims, among others, the solutions relating to the invention are characterised by what is disclosed in the characterising parts of the appended independent claims.

A typical building according to the invention is transportable by water but intended to be used when stationary. The invention is based on the unexpected observation that a building transportable by water may consist of at least two structurally separate parts, namely a transport part and a functional part. Both of the said parts are intended to be used by people, but in different situations.

The transport part comprises the means for transporting the building, such as an engine, fasteners for towing means, navigation means and/or rescue means, and premises for accommodating the personnel responsible for the transport during the transport. Thus, the means for transporting the building do not necessarily include an engine, but means for coupling the building, for example, to a tugboat. The transport part is dimensioned for a number of people A, in other words the transport premises meet, for example, the safety regulations required of waterborne vessels up to a number of persons A. The functional part is that part of the building that is intended for the use of clients when the building is stationary. The functional part may comprise, for example, hotel rooms, restaurants, office premises or shops. The premises in the building have been built so as to meet the regulations for building on land. The premises are dimensioned for a number of people C when the building is stationary on site, that is, not under transportation. The maximum number of clients C is typically much greater than the number of transport personnel A.

The functional part of a typical building according to the invention does not meet the regulations required of a waterborne vessel, such as safety regulations, and thus when the building is transported by water, there may be a maximum of A persons in the building.

The method relating to the invention for arranging delivery of an additional building to a desired location utilises the building relating to the invention, which is transportable by water. The method includes at least the following stages:

a) a client needing premises informs the provider of the premises of this need,

b) the client and the provider of the premises agree at least on the place of delivery and time of delivery of the additional building, and

c) the provider of the premises delivers the building relating to the invention, which is transportable by water, to the agreed place at the agreed time.

In this context, an additional building refers to a building or structure that adds additional premises corresponding to the premises provided by the building at its location. The location does not necessarily previously comprise premises corresponding to the premises provided with the method of the invention, but the additional building may be the first and only building of that type.

By means of the building and method relating to the invention considerable advantages are achieved compared to the state-of-the-art technology. The need for additional buildings can be satisfied flexibly, that is, either one or several buildings may be delivered according to need and availability. The transportation of the buildings is fast and safe because only the personnel required for the transportation is in the building during transportation. The building according to the invention does not constitute a great environmental load on the harbour of destination. Energy supply and waste management facilities must be obtained on shore, at least during longer stays, but extensive construction work is not required. Since the buildings relating to the invention are preferably built to resemble impressive cruise ships, the watersides of the harbours of destination are improved and brought into active use. Transportable buildings do not spoil anyone's view permanently. It is easy to make a building resembling a ship most seaworthy. The engine-power does not, however, have to equal that of a cruise ship, and smaller engines are sufficient. This saves space for the functional premises.

The functional part of a preferred building according to the invention further comprises a service part, that is, service means and service premises for servicing the premises of a stationary building. In order to function, the service means require a service personnel numbering B. The service part is typically not built or equipped in compliance with marine regulations, thus the personnel are not permitted to enter the building until it has been moored.

A particularly advantageous building according to the invention or its part functions as a hotel or similar accommodation for people. In such a case, the service part includes the service and auxiliary premises required by a hotel or the like, such as reception, restaurant, spa or laundry facilities.

According to one embodiment of the invention, a building is moored at its location in the harbour in such a way that its functional premises and service premises must comply with the regulations for building on land at the harbour location, for example, as concerns rescue regulations, safety and waste management.

Preferably in the method according to the invention, the date of the termination of delivery is also agreed on, in which case the method also comprises a stage d): the provider of the premises transports the additional building on the agreed date from its second location to a third location, that is, transports it away. Two or more additional buildings may be ordered to the same place, and they may be delivered from more than one place. They may also be transported away to more than one new location.

The system according to the present invention for managing the spatial capacity provided at a geographical location preferably comprises several buildings that are movable by water and functionally connectable, and the size of the spatial capacity and the number of buildings required to provide it are determined on the basis of the spatial capacity requirement at any time. In a very advantageous system one or more of the buildings as described in claim 1 are used.

In such a case, the size of the total spatial capacity of, for example, a hotel can, if necessary, be increased or reduced by providing, in connection with the building or buildings forming the spatial capacity, additional buildings that are functionally connected to one or more buildings previously located on the site.

The reservation system according to the invention for reserving one or more buildings and the premises they contain comprises at least

data terminal equipment

at least one server, and

a database that maintains the reservation status of the said one or more buildings and the premises they contain.

Communication links can be created both between the data terminal equipment and the server and between the server and the database. Data transmission can be carried out by any suitable electronic means, for example, over the Internet, using so-called Voice Over Internet Protocol (VOIP), which provides an easy and economical way of adding new modules to the system. The data terminal equipment may, for example, be reservation servers used via the Internet, or conventional data terminal equipment as used by travel agencies. In addition to the above, the system comprises at least the means mentioned under the following points aa)-ee):

aa) means for entering a space reservation inquiry from the data terminal into the system. This means refers, for example, to the user interface of a data terminal. The space reservation inquiry includes information at least on which premises, or what part of the premises and in which building covered by the system, the reservation is to be made, and the date when the reservation is required;

bb) means for searching in the database whether it is possible to meet the order stated in the space reservation inquiry. This search is typically carried out by means of a program in the server;

cc) means for updating the database to correspond to the order referred to in the space reservation inquiry, in cases where the order can be accepted;

dd) means for replying to the data terminal as regards realisation of the conditions of the order given in the inquiry, that is, it is stated whether the reservation could be made or not;

ee) means for changing the reservation status of a building or its part in the database, if so desired, irrespective of the reservation status of the building or its part prior to this change. These means can be accessed, for example, by the system supervisor or equivalent. This type of forced data entry is necessary, for example, when a building or part of it has to be closed for some reason. Also, for example, the prices of the premises to be reserved can be changed through this means. According to the invention, information on the geographical location, on a certain date, of at least one of the buildings to be reserved, is also maintained in the database, and this location data can be changed using the means mentioned under ee).

At least one of the buildings to be reserved by means of the reservation system according to the invention is preferably a building transportable, if desired, by water from one place to another. Most preferably, one or more of the means mentioned under points aa) to ee) are located in the said building, which is transportable, if desired, by water from one place to another.

Preferably, the reservation system of the invention further comprises:

ff) means for receiving clients' orders as messages separate from the system, such as messages by telephone, on paper or by e-mail, and for converting these messages further via the data terminal equipment into a space reservation inquiry. These means refer, for example, to a so-called Call Centre, to which clients making reservations call, and whose personnel handles the making of reservations on a terminal. The Call Centre or similar means is preferably located in a building reserved through the same system and transportable, if so desired, by water from one location to another.

The reservation method relating to the invention uses the reservation system described above.

### A BRIEF DESCRIPTION OF THE DRAWINGS

The invention is described in greater detail below, with reference to the appended Figures, in which

FIG. 1 shows diagrammatically the building according to the invention,

FIG. 2 shows diagrammatically the reservation system according to the invention, and

FIGS. 3 and 4 show diagrammatically an example of an embodiment of the invention.

### A DETAILED DESCRIPTION OF PREFERRED EMBODIMENTS

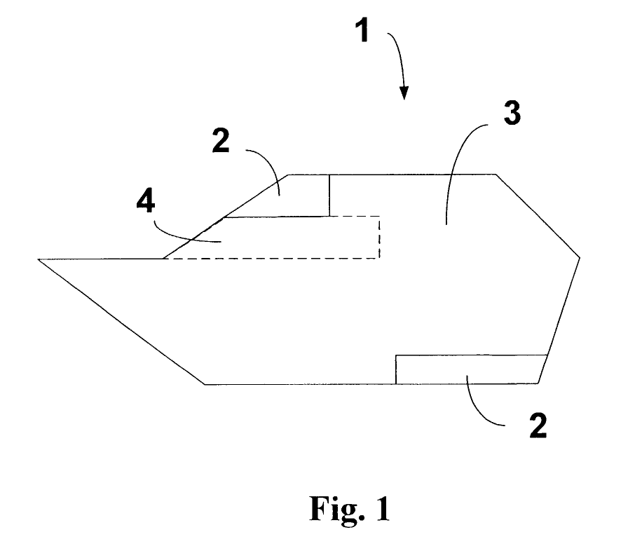

FIG. 1 describes in box-like form, how the hotel 1 according to the invention, which is transportable by water, comprises three parts: a transport part 2, a functional part 3 and a service part 4.

The transport part 2 comprises the equipment and premises for moving the building, such as the engine room, the navigation bridge and navigation means. One or more tugboats can, for example, also be used to transport the building, in which case the building need not necessarily comprise any engines for moving the building. The transport part 2 also comprises accommodation for the crew carrying out the transport, and the rescue means required for the crew, such as lifeboats. The transport part is built as a conventional ship and it meets all the regulations set for ship's premises. A maximum number of people A is determined for the transport part, this number being sufficient for the safe transportation of the building.

The functional part 3 comprises hotel rooms and the corridors between them, which the clients of the hotel may reserve for their use by means of the reservation system and method relating to the invention. The functional part 3 meets all the regulations for a hotel moored in a harbour for a long period, or even for an ordinary hotel built on land. The fire authorities, for example, may require certain safety solutions for a floating building remaining in a harbour for a long period of time. The functional part 3, that is, the hotel, is dimensioned for a number of clients C when the building is moored. The building further comprises a service part 4, which includes the hotel's reception premises, restaurants and other auxiliary premises needed in a hotel, the running of which requires B persons. Typically, the number of clients C is much greater than A or B. The number of crew A required for transporting the building may, for example, be 5 to 20, whereas the number of overnight guests C at the hotel in the functional part 3 may, for example, be 200 to 1000 persons. The service personnel B may consist, for example, of a few dozen persons. The transport part 2 and the functional part 3 may be structurally separate from each other in such a way that it is not possible to enter the functional part 3 from the transport part 2 during the transportation of the building.

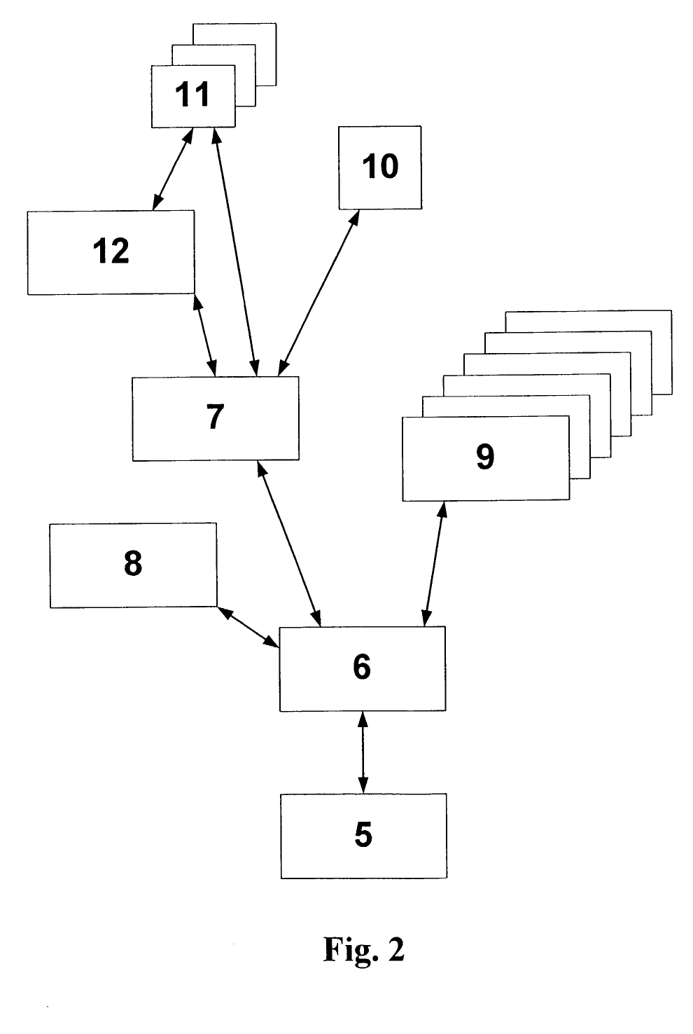

FIG. 2 shows the reservation system and reservation method relating to the invention. The arrows in the Figure represent data communication. The database 5 stored in an electric storage medium serves to maintain the reservation status of one or more buildings and the premises they contain. In the case of hotels, for example, the database contains the reservation data on the different rooms. The database 5 is updated and inquiries on its status are made by means of software stored in the storage medium of the server 6. Reservation inquiries concerning the premises may be sent to the server 6 by using the data terminals 7, 8 and 9. Data terminal 7 represents a server operating in the Internet and the reservation software running in it, which any client 10, 11, 12 may access. The user may be required to register. Data terminal 8 depicts a conventional terminal system, such as is used, for example, by travel agents, examples of trademarks being GALILEO, AMADEUS, GDS and MICROSFIDELIO. The data terminals 9 represent terminals located in the buildings reserved through the system. Most preferably, the terminals 9 are located in the buildings 1 transportable by water according to the invention. The data terminals, as well as the Internet reservation program 7 can be used in various ways. Clients 11 may themselves make direct contact with the data terminal. This is also the procedure followed by the main user 10 of the system, who is identified by the system, for example, by means of a particular protected password. It is also possible to establish centralised service points, such as a so-called Call Centre 12, which clients may contact, for example, by telephone. The Call Centre 12 personnel will handle the space reservation inquiry on the data terminal on behalf of the client. The Call Centres 12 are economical to run because in this way, for example, when setting up or adding new hotels to the system, no new service centre need be established. One Call Centre 12 will have the capacity to serve the entire world. Most advantageously, the parts of the system, such as the database 5, server 6 and Call Centre 12, will be located in the buildings transportable by water relating to the invention.

The reservation status data can also be used, for example, in such a way that on the basis of this data, the number of rooms available for reservation can be increased by ordering or by otherwise acquiring spatial capacity in the form of a building brought to the site by water. During periods of lower demand, excess accommodation capacity may also be reduced by handing over or renting a part of the capacity providing the accommodation capacity to another party by delivering a building transportable by water, which is included in the accommodation capacity, such as a building according to the invention, to a location requested by the party in need of premises.

The data terminals may also be mobile using, for example, Wireless Application Protocol (WAP) for contacting the server 6 or an Internet data terminal 7. The space reservation inquiry typically includes, for example in connection with a hotel reservation, information on the hotel or town in which the client wishes to reserve a room, the type and/or price of room he is interested in, and the period for which the reservation is to be made. In addition, the inquiry usually includes the name and contact information of the reserving person and the identification data of a credit card or other means of payment. Should it not be possible to meet the terms of the space reservation inquiry, the system will preferably suggest an alternative in the vicinity.

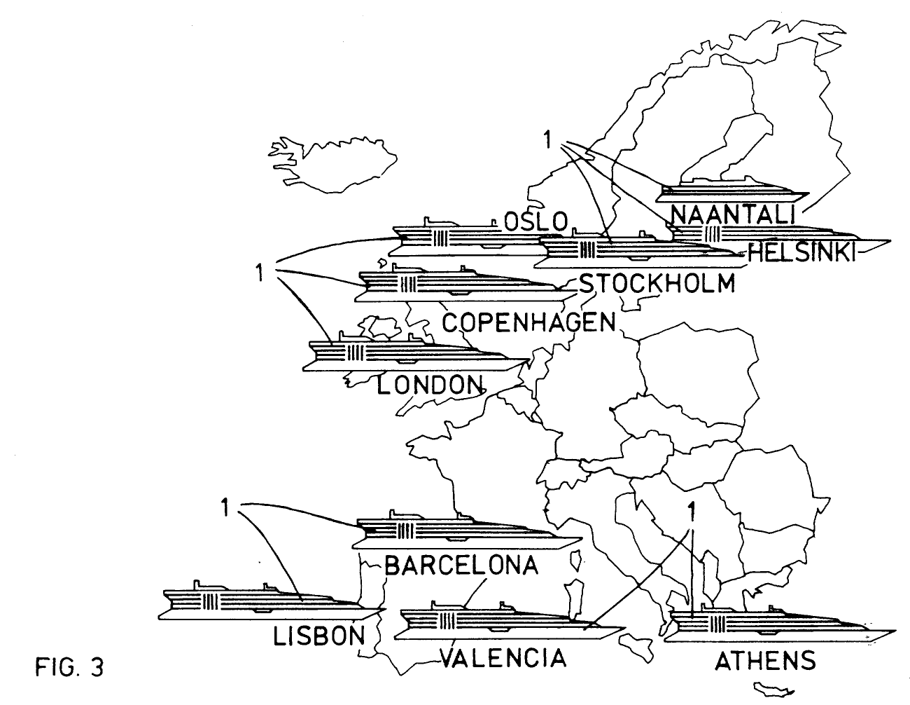

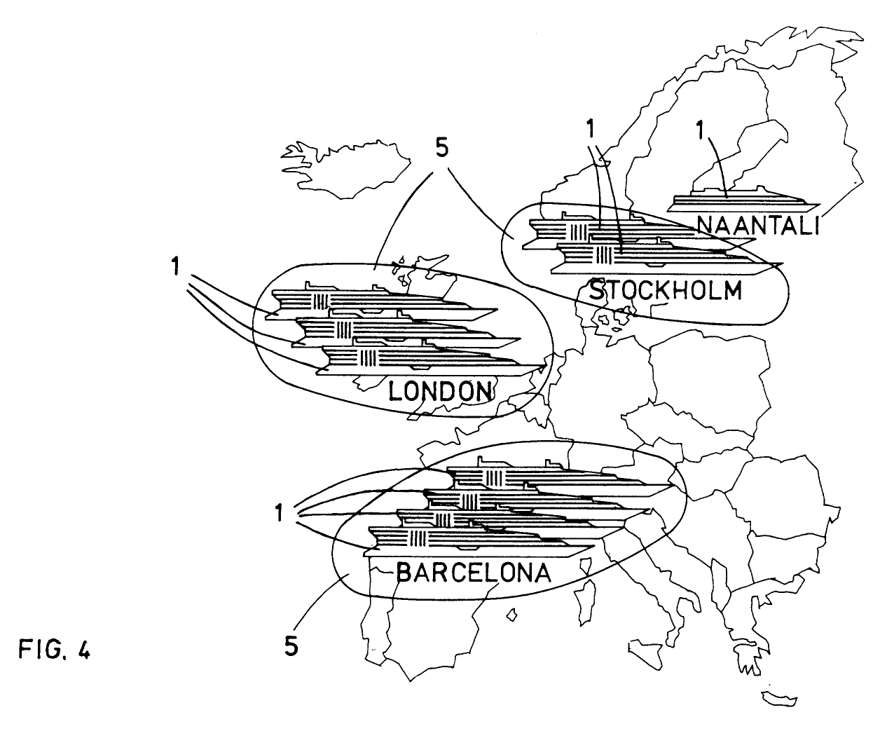

The reservation system and reservation method can also be implemented and utilised in such a way that the system is used for reserving entire buildings, as shown in FIGS. 3 and 4. In such a case, for example, the organisers of large mass events, such as fairs, may order and reserve for their use accommodation and/or spatial capacity in the form of one or more of the buildings according to the invention. For example, the organisation arranging Formula 1 races may order the required accommodation capacity to the race venue or its vicinity, in which case the required number of vacant buildings is delivered from an appropriate geographical location to the ordered location.

This means that by using the reservation system and method relating to the invention a system can be realised by the use of which orders and reservations can be received, for example, for accommodation capacity at a site, when the capacity itself is not yet at the said site, but which capacity is transported to the site for the time reserved.

In accordance with FIGS. 3 and 4, the buildings transportable by water, which are preferably buildings 1 according to the present invention, form a kind of fleet, which comprises the buildings 1, which can be transported to a desired geographical location to provide spatial capacity and a spatial entity of the desired type and size. FIGS. 3 and 4 show, by way of an example, a fleet of ten vessels which are, as shown in FIG. 3, spread geographically by locating the buildings in different parts of Europe to form their own spatial capacity 5. The buildings are located in Naantali, Helsinki, Stockholm, Oslo, Copenhagen, London, Barcelona, Lisbon, Valencia, and Athens. The locations of the buildings are merely examples of possible locations. The fleet may also comprise buildings that have not been placed at a specific geographical location, but which may be waiting to be placed, for example, at the most advantageous intermediate location, such as a harbour.

The buildings shown in FIG. 3 may differ from one another, which means that they can be used to provide exactly the desired type of spatial entity to achieve the desired spatial capacity. The spatial capacity may comprise, for example, accommodation or office premises, factory premises or hospital premises. The present system and method according to the invention for arranging the provision of an additional building at a desired location makes it possible, in one of its preferred embodiments, to manage and control the geographical location of the buildings comprising the type of fleet described.

FIG. 4 shows a situation where there is a particularly high demand for spatial capacity, in which case the spatial capacity of the localities in question has been increased by transporting buildings from other localities to the said sites in order to form new spatial entities 5. According to the Figure, the new spatial entity 5 formed in Barcelona comprises four buildings, the new spatial entity 5 formed in London comprises three buildings, and the spatial entity 5 formed in Stockholm comprises two buildings. A new spatial entity 5 could also be arranged to be delivered to a site where there was previously no building. Once the peak demand for spatial capacity has ceased, the buildings 1 can be transported, for example, back to their places of departure as shown in FIG. 3, or alternatively to another location.

Although the above examples refer mainly to the reservation of hotel premises, it should be pointed out that the invention is not limited to the above examples, but the invention is intended to cover the applications defined in the claims. The premises contained in the buildings relating to the invention, which can be reserved by means of the reservation method and reservation system according to the invention, may serve, for example, as a hotel, a residential building, an office, a hospital, temporary accommodation in catastrophe areas, an emergency centre, a military firing control centre, research and development premises or an industrial plant, such as a mobile telephone factory.

1. A building transportable by water, but intended to be used especially when stationary, which comprises at least
means for transporting the building and transport premises for accommodating the personnel operating the means, the said transport means and transport premises being dimensioned for a number of transport personnel A, and which transport premises meet the safety regulations required of a waterborne vessel, and
functional premises, which can be reserved by clients for their own use, the functional premises being dimensioned for a maximum number of clients C,
characterised in that the maximum number of clients C is greater than the number of transport personnel A, and that the functional premises of the building do not meet the safety regulations required of a waterborne vessel, which means that when the building is transported by water, there may be a maximum of A persons in the building.

2. A building as claimed in claim 1, characterised in that it further comprises service means and service premises for servicing the functional premises of the building, the said service means requiring a number of service personnel B in order to function.

3. A building as claimed in claim 1, characterised in that the functional premises comprise hotel rooms or corresponding accommodation for people.

4. A building as claimed in claim 3, characterised in that its functional part further comprises the service or auxiliary premises needed by a hotel or the like, such as reception premises and a restaurant, which require a number of service personnel B in order to function.

5. A method for arranging the delivery of an additional building to a desired location, the method including at least the following stages:
a) a client needing premises informs the provider of the premises of this need,
b) the client and the provider of the premises agree at least on the place of delivery and time of delivery of the additional building, and
c) the provider of the premises delivers the additional building to the agreed place at the agreed time, characterised in that the additional building delivered at stage c) is a building according to claim 1, which is transported by water from its first location to the agreed place of delivery, that is, its second location.

6. A method as claimed in claim 5, characterised in that the termination date of the delivery is also agreed at stage b), and that the method also comprises a stage
d) the provider of the premises transports the additional building at an agreed time from its second location to its third location.

7. A method as claimed in claim 5, characterised in that in the method, two or more additional buildings are delivered to the same second location from more than one first location.

8. A system for managing the spatial capacity provided at a geographical location, characterised in that the spatial capacity comprises several buildings, which are movable by water and functionally connectable, and that the size of the spatial capacity and the number of buildings required to provide it are determined on the basis of the spatial capacity requirement at any time.

9. A system as claimed in claim 8, characterised in that the system uses one or more of the buildings disclosed in claim 1.

10. A reservation system for one or more buildings and the premises they contain, which comprises at least data terminal equipment, at least one server, and a database used for maintaining the reservation status of the said one or more buildings and the premises they contain, whereby data communication links can be created both between the data terminal equipment and the server and between the server and the database, the system comprising at least
aa) means for entering a space reservation inquiry from the data terminal into the system, which inquiry includes information at least on which premises, or what part of the premises and in which building covered by the system, a reservation is to be made, and the date when the reservation is required,
bb) means for searching in the database to find out whether it is possible to meet the order stated in the space reservation inquiry,
cc) means for updating the database to match the order referred to in the space reservation inquiry,
dd) means for replying to the data terminal as regards meeting the conditions of the order given in the inquiry,
ee) means for changing the reservation status of a building or a part of it in the database, if desired, irrespective of the reservation status of the building or the part of it prior to this change,
characterised in that the database is arranged to contain information on the geographical location, on a certain date, of at least one building to be reserved, the location data being arranged so that it can be changed using the means disclosed under ee).

11. A reservation system as claimed in claim 10, characterised in that of the buildings to be reserved through the system, at least one is transportable, if so desired, by water from one place to another.

12. A reservation system as claimed in claim 10, characterised in that one or more of the means mentioned under points aa) to ee) are located in the said building transportable by water from one place to another.

13. A reservation system as claimed in claim 11, characterised in that the building transportable by water from one place to another is a building according to claim 1.

14. A reservation system as claimed in claim 10, characterised in that it further comprises:
ff) means for receiving clients' orders as messages separate from the system, for example by telephone, on paper or by e-mail, and for converting these messages further via the data terminal equipment into a space reservation inquiry.

15. A reservation system as claimed in claim 14, characterised in that the means mentioned under ff) are located in a building to be reserved through the system, which building is transportable, if so desired, by water from one place to another.

16. A method for reserving one or more buildings and the premises they contain through a reservation system that comprises at least data terminal equipment, at least one server and a database, whereby data communication links can be created, if necessary, both between the data terminal equipment and the server and between the server and the database, by means of which method the database serves to maintain information on the reservation status of the said one or more buildings and the premises they contain, in which method
aaa) a space reservation inquiry is entered into the data terminal, the inquiry including information at least on which premises, or what part of the premises and in which building covered by the system, a reservation is to be made, and the date when the reservation is required,
bbb) the space reservation inquiry is sent to the server,
ccc) the database is searched to find out whether it is possible to meet the order stated in the inquiry, and if the order can be met, then ddd) the order is made by updating the database with the information contained in the inquiry, and
eee) the data terminal is given a reply regarding the possibility of meeting the conditions of the order given in the inquiry, in which method is also, if necessary,
fff) the reservation status of a building or a part of it in the database is changed, if so desired, irrespective of the reservation status of the building or the part of it prior to this change,
characterised in that information on the geographical location, on a certain date, of at least one of the buildings to be reserved is maintained in the database, which location data can be changed at stage fff).

17. A method as claimed in claim 16, characterised in that of the buildings to be reserved by the method, at least one is a building that is transportable, if so desired, by water from one place to another.

18. A method as claimed in claim 17, characterised in that the building that is transportable by water from one place to another is a building according to claim 1.

19. A method as claimed in claim 16, characterised in that it comprises a further stage
ggg) at which clients' orders are received as messages separate from the system, for example by telephone, on paper or by e-mail, and the information contained in these messages is converted further via the data terminal equipment into a space reservation inquiry.

20. A method as claimed in claim 19, characterised in that the conversion at stage ggg) is carried out in a building to be reserved through the system, which building is transportable, if so desired, by water from one place to another.
